(19) United States
(12) Patent Application Publication
(10) Pub. No.: US 2020/0078822 A1
(43) Pub. Date: Mar. 12, 2020

(54) Method for Automated Spraying of Nanoparticles

(71) Applicant: University of Louisiana at Lafayette, Lafayette, LA (US)

(72) Inventors: Ahmed Khattab, Lafayette, LA (US); Wan Shou, Lafayette, LA (US); Pengfei Zhang, Lafayette, LA (US)

(21) Appl. No.: 16/564,037

(22) Filed: Sep. 9, 2019

Related U.S. Application Data
(60) Provisional application No. 62/728,367, filed on Sep. 7, 2018.

(51) Int. Cl. B05D 1/12; G05B 19/418; B82Y 40/00; B82Y 30/00

(52) U.S. Cl. CPC B05D 1/12; G05B 19/418; B01D 2323/26; B82Y 30/00; B82Y 40/00

(57) ABSTRACT

The present invention is a method of automated nanoparticle spraying and an apparatus for same. In one embodiment, the nanoparticles are sprayed over reinforced fabrics, such as for the manufacturing of composite materials. The developed method can control the amount of nanoparticles to be added to the composites with the capability to selectively reinforce localized areas of the fabrics based on the load distribution for a given application.

### CROSS REFERENCE TO RELATED APPLICATIONS

This application claims priority to U.S. Provisional Application No. 62/728,367 entitled “Method for Automated Spraying of Nanoparticles” and filed Sep. 7, 2018.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the Method for Automated Spraying of Nanoparticles, which may be embodied in various forms. It is to be understood that in some instances, various aspects of the invention may be shown exaggerated or enlarged to facilitate an understanding of the invention. Therefore the drawings may not be to scale.

FIG. 1 is a drawing of the developed automated spray system.

FIG. 2 is a comparison of experimental and model results for CNFs sprayed dosage (μg/mm2).

FIG. 3 is a graph of the average main effect plots of process parameters: (a) spray velocity; (b) air pressure; (c) number of sprayed layer on CNFs sprayed dosage (μg/mm2).

FIG. 4 is a process maps of CNFs sprayed dosage, tg/mm2 of the sprayed fabric, as a response to (a) air pressure and spray velocity; (b) number of sprayed layers and spray velocity; (c) number of sprayed layers and air pressure.

FIG. 5 is a graph of the recommended contour plot of CNFs sprayed dosage as a response to (a) air pressure and spray velocity; (b) number of sprayed layers and spray velocity; (c) number of sprayed layers and air pressure.

FIG. 6 is a graph of the influence of air pressure on morphology of sprayed fabrics: (a) and (c) are for a specimen sprayed with an air pressure of 124 kPa, under low and high magnification; (b) and (d) are for a specimen sprayed with an air pressure of 179 kPa, under low and high magnification.

FIG. 7 is a graph of the influence of spray velocity on morphology of sprayed fabrics: (a) and (c) are for a specimen sprayed with a spray velocity of 15 mm/s, under low and high magnification; (b) and (d) are for a specimen sprayed with a spray velocity of 75 mm/s, under low and high magnification.

FIG. 8 is a graph of the influence of number of sprayed CNF layers on morphology of the sprayed fabrics: (a) and (c) are for a specimen sprayed with 3 layers, under low and high magnification; (b) and (d) are for a specimen sprayed with 7 layers, under low and high magnification.

FIG. 9 is SEM images of sprayed fabrics: (a), (c) manual spray under 2000 and 10000 magnification; (b), (d) automated spray under 2000 and 10000 magnifications.

### BACKGROUND

Nano-coating is a technique that distributes nanomaterials onto a substrate, imparting the substrates with new properties, such as fire retardant, anti-microbial, superhydrophobic, etc. Due to their excellent properties, carbon nanofibers (CNFs) have been widely applied in composite materials in order to fabricate advanced nanocomposites with enhanced mechanical, electrical, and thermal properties.

Usually, nanoparticles are mixed with resin and injected into fabricate nanocomposites, however, such a method increases the viscosity of nanophased resin and makes the resin flow slowly, which extends the filling time, resulting in premature cure and incomplete saturation of the fabrics, as well as introduction of voids. Another problem is the so called filtration effect, during the injection process, in which nanoparticles can be filtered through the preform, generating an inconsistent microstructure and uncertainty in the actual amount of nanoparticles in the molded composites.

In order to address the above problems, various indirect dispersion methods have been reported, such as chemical vapor deposition (CVD), electrophoretic deposition, and spray. These methods all work well to achieve good distribution; however, the spray technique is generally the most economical and straightforward one. But, no current prior art discloses an automated spray process for nanoparticle dispersion in reinforced fabric (such as composite) manufacturing.

The present invention is a method and system for performing an automated nanoparticles spray process. It allows for an unprecedented 3D multi-scale control of reinforcements, which will allow an engineer to control the reinforcement type, volume fraction, and size of reinforcing particles at specific locations in the composite part or other reinforced fabric. This can enable precision 3D micro-structural control for targeted properties and applications.

This spray process not only facilitates the dispersion of CNFs in composites, but it can also be used for ultrathin film fabrication and nanocoating with precise control using any nanomaterial. As the spray process is simple and effective, a considerable yield of ultrathin film can be achieved. Furthermore, gradient and patterned spray can be achieved. Therefore, the inventive spray method holds great capability and potential for industrial application.

### DETAILED DESCRIPTION

The present invention is a method of automated nanoparticle spraying and an apparatus for same. In one embodiment, the nanoparticles are sprayed over reinforced fabrics, such as for the manufacturing of composite materials. The developed method can control the amount of nanoparticles to be added to the composites with the capability to selectively reinforce localized areas of the fabrics based on the load distribution for a given application.

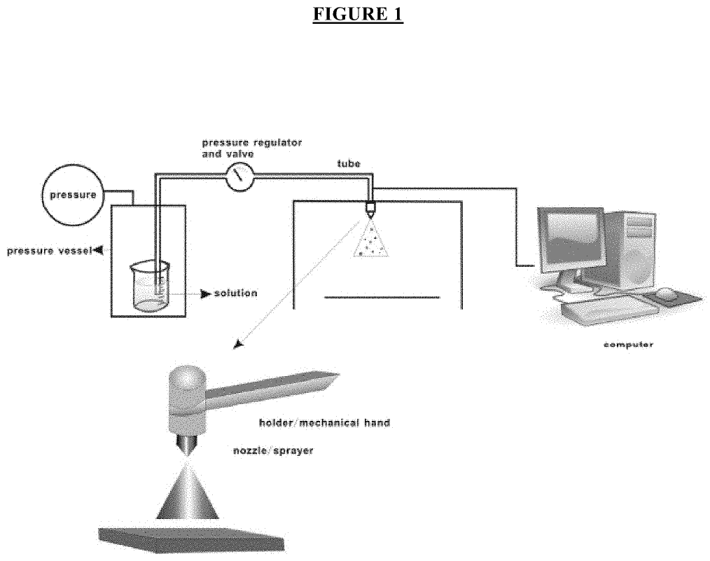

As shown in FIG. 1, the automated spray systems consists of two pressure suppliers: one to supply the pressure in pressure vessel, where a solution reservoir is located—working as liquid pressure for the process, and the other as the air pressure. The pressure regulator and gauge are connected with a tube near the atomizing sprayer (for example, ¼J+SU12A, purchased from Spraying System Co. may be sued; however, any other suitable atomizing sprayer may be used). The sprayer is fixed in the griper of a robotic arm (for example, a Scorbot ER 4PC may be used; however, any suitable automated machine or mechanical arm apparatus suitable for the task may be used), which is controlled by the user through a computer. During the spray process, the spray distance (from nozzle to fabric) is fixed. In one embodiment, the distance is at 508 mm (20 in). However, in other embodiments, other distances may be used depending on the application. Liquid pressure and air pressure are controlled using the pressure regulator. The robotic arm is controlled by the user through a computer so that it moves in a straight line with adjustable velocity.

The spray solution is prepared by dispersing nanoparticles into a solvent. In one embodiment CNF is used as the nanoparticle and acetone is used as the solvent. In other embodiments other natural, synthetic, or hybrid nanoparticles may be used as well as other suitable solvents. A suitable dispersion is 2.5 g CNF into 400 ml of acetone. However, in other embodiments, varying amounts of nanoparticles and solvent may be used.

Once the nanoparticles are dispersed into the solvent, sonication is conducted as known in the art. Then the nanoparticle-solvent solution is cooled in water for a suitable period of time, such as between 5 minutes and one hour. In one embodiment, sonication is conducted at 240 w (20 Hz) power and 90% pulse of the maximum value for 8 min, followed by 25 minutes of cooling in water. In one or more embodiments, the sonication process and cooling is repeated two more times.

Any suitable fabric may be used as well as any suitable fabric frame. In one embodiments, the fabrics are put on an aluminum screen during the spray process, and then following the spray, the fabrics were left to dry at room temperature for 24 hours before being weighed. The CNFs dosage sprayed on the fabric is determined by the weight difference between the fabric before and after the spray process.

The method produces 3D control of the distribution of nanomaterials. In order to measure the variables and to create process maps for spraying designed CNF dosages the response surface methodology (RSM) is used. In this methodology, a low order polynomial is fitted between the response parameters of the process. A three parameter RSM with central composite design was adopted. The design involves a fraction of first-order (2ⁿ) factorial design, two “star points” on the axis of each design variable, and one center point. The parameters are determined for five levels that cover a wide range of process conditions. The levels are represented by the commonly used codes (−1, +1, 0) on the factorial portion of the design, and values (−2, +2) on the axial portion. Table 1 displays the parameters, corresponding levels, and values. The process variables

TABLE 1

| | Spray Velocity | Number | |
|---|---|---|---|
| Level | (mm/s) | Layers | AirPressure |
| −2 | 15 | 1 | 97 [14] |
| −1 | 30 | 3 | 124 [18] |
| 0 | 45 | 5 | 152 [22] |
| 1 | 60 | 7 | 179 [26] |
| 2 | 75 | 9 | 207 [30] |

in the design include: the sprayer speed, liquid pressure (LP) and air pressure (AP). This design leads to 15 different cases with different combinations of process variables. Every case may be repeated at least three times for accuracy.

A low order polynomial is used to establish a relation between objective function and factors. Here, a regression model with the following form is adopted:

$$\begin{matrix}y = {β}_{0} + {\sum }_{j = 1}^{k} {β}_{j} {x}_{j} + \sum {\sum }_{i < j} {β}_{ij} {x}_{i} {x}_{j} + {\sum }_{j = 1}^{k} {β}_{jj} {x}_{j}^{2} & ( 1 ) \\ y = {β}_{0} + {β}_{1} {x}_{1} + {β}_{2} {x}_{2} + {β}_{3} {x}_{3} + {β}_{4} {x}_{1} {x}_{2} + {β}_{5} {x}_{1} {x}_{3} + {β}_{6} {x}_{2} {x}_{3} + {β}_{7} {x}_{1}^{2} + {β}_{8} {x}_{2}^{2} + {β}_{9} {x}_{3}^{2} & ( 2 )\end{matrix}$$

### Where:

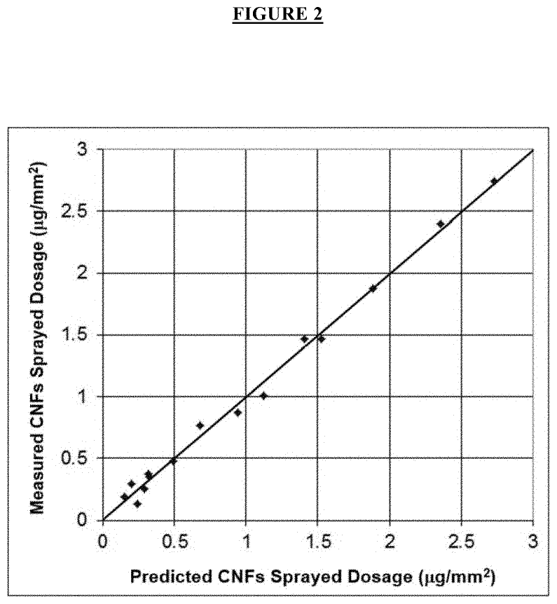

y: Sprayed CNFs dosage (μg/mm2), sprayed CNFs weight/area of fabric;
x₁: Spray velocity;
x₂: Number of spray layers;
x₃: Air pressure;
β₀: Average response;
β₁, β₂, . . . , β₉: regression coefficients.
Table 2 shows the effect of the process parameters on the experimental results and the predicted results using the developed model. The errors between the model and the experimental data were listed in Table 2. The minimum and maximum errors are 0.2% and 80.4% respectively. The average error is 14.2% (corresponding to 0.39 μg/mm² when the highest dosage was sprayed) and over half of the cases the errors are less than 5%, indicating a good prediction of this model. Table 2 depicts the general trend that the higher the CNFs dosage, the smaller the error. It is also observed from Table 2 that from the highest CNFs sprayed dosage (μg/mm²) to the lowest, the standard deviation within each case decreases, which may relate to the accumulation effect of small differences resulting from multilayer spraying. Through the coefficient of variation (CV) from experiment number 13 to 15, it is observed that increasing the spray layer can first decrease the CV and then increase the CV; in some degree, the multilayer spraying can overcome the uncertainty of one-layer spray, making the coating uniform and consistent. A comparison between the inventive method data and model results is shown in FIG. 2. As shown in the figure, majority points are on the line or close to the line, proving the good matching of the developed model and inventive method results.

TABLE 2

| | | Air | | | | | | |
|---|---|---|---|---|---|---|---|---|
| | Spray | Pressure | Number | Measured | | | Predicted | |
| Case | Velocity | (kPa) | of | Dosage | Standard | | Dosage | Error |
| No. | (mm/s) | [psi] | Layers | (μg/mm²) | Deviation | CV | (μg/mm²) | (%) |
| 1 | 30 | 124 [18] | 3 | 1.4700 | 0.1338 | 9.1% | 1.5253 | 3.8 |
| 2 | 30 | 124 [18] | 7 | 2.7458 | 0.2372 | 8.6% | 2.7290 | 0.6 |
| 3 | 30 | 179 [26] | 3 | 0.4760 | 0.0404 | 8.5% | 0.4959 | 4.2 |
| 4 | 30 | 179 [26] | 7 | 1.0083 | 0.0983 | 9.7% | 1.1260 | 11.7 |
| 5 | 60 | 124 [18] | 3 | 0.3483 | 0.0301 | 8.7% | 0.3232 | 7.2 |
| 6 | 60 | 124 [18] | 7 | 0.8720 | 0.0994 | 11.4% | 0.9446 | 8.3 |
| 7 | 60 | 179 [26] | 3 | 0.1360 | 0.0129 | 9.5% | 0.2454 | 80.4 |
| 8 | 60 | 179 [26] | 7 | 0.2560 | 0.0198 | 7.7% | 0.2932 | 14.5 |
| 9 | 15 | 152 [22] | 5 | 2.3992 | 0.1390 | 5.8% | 2.3574 | 1.7 |
| 10 | 75 | 152 [22] | 5 | 0.3733 | 0.0242 | 6.5% | 0.3225 | 13.6 |
| 11 | 45 | 97 [14] | 5 | 1.8783 | 0.1211 | 6.4% | 1.8816 | 0.2 |
| 12 | 45 | 207 [30] | 5 | 0.2967 | 0.0271 | 9.1% | 0.2008 | 32.3 |
| 13 | 45 | 152 [22] | 1 | 0.1890 | 0.0134 | 7.1% | 0.1556 | 17.7 |
| 14 | 45 | 152 [22] | 9 | 1.4662 | 0.1433 | 9.8% | 1.4072 | 4.0 |
| 15 | 45 | 152 [22] | 5 | 0.7712 | 0.0379 | 4.9% | 0.6787 | 12.0 |

In order to determine the process parameters that are statistically significant, Analysis of Variance (ANOVA) on the method data was conducted and the results are shown in Table 3. The p-value of source spray velocity, air pressure, and

TABLE 3

| Source | DF | Adj SS | Adj MS | F | P |
|---|---|---|---|---|---|
| Spray Velocity | 1 | 413969889 | 413969889 | 35.29 | 0.000 |
| Air Pressure | 1 | 282422029 | 282422029 | 24.07 | 0.000 |
| Number of Layers | 1 | 156583511 | 156583511 | 13.35 | 0.004 |

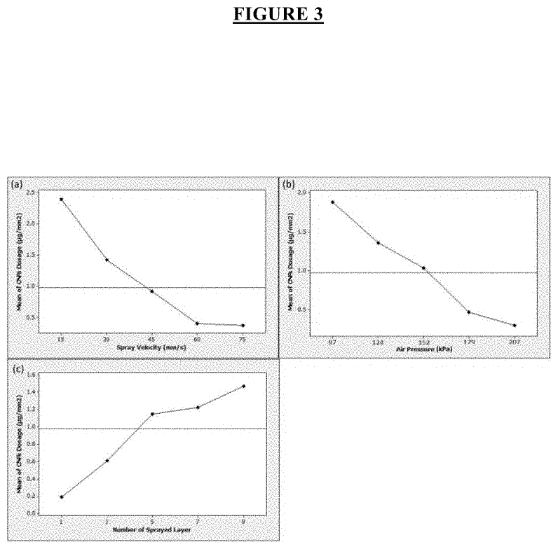

number of layers are 0.000, 0.000, and 0.004, respectively. All of these are smaller than 0.05, indicating that there is a higher than 95% of confidence to conclude that all of the three parameters' effect on the sprayed CNFs dosage are significant parameters. The main effects plots are shown in FIG. 3, where the sprayed CNFs dosage drops with the rise of spray velocity and air pressure. It is also noticed in FIG. 3 (a), when the spray velocity reaches 60 mm/s, the slop becomes flat, indicating the influence of spray velocity may fade out if it reaches above a certain threshold. Meanwhile, it is observed in FIG. 3 (c) that the growth of spray layer increases the sprayed CNFs dosage as expected due to the accumulation of deposited CNFs. Both the ANOVA and the main effect plots demonstrate that the inventive method's control of spray velocity, air pressure, and number of sprayed layer play vital roles on the deposited CNFs dosage.

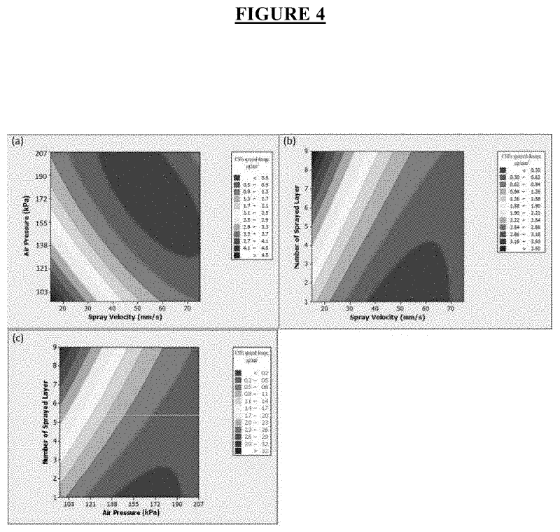

The process maps are shown in FIG. 4 for one embodiment of the inventive method where CNF is sprayed and 1 g/mm² of the sprayed fabric is used. The interactive effects on the CNFs sprayed dosage are observed from the process maps. FIGS. 4 (a) and (c) show the general trend that the response decreases with the increase of spray velocity and air pressure, similar to the main effect plots; however, the response will remain the same when either of the above factors is over its threshold, i.e. when spray velocity is beyond 50 mm/s, the CNFs sprayed dosage does not change significantly; when air pressure is over 172 kPa (25 psi), the response remains approximately the same. In other words, only in certain range, the process has good control of the response. FIGS. 4 (b) and (c) show that the CNFs sprayed dosage increases with the number of sprayed layer, which is in consistent with the main effect plot.

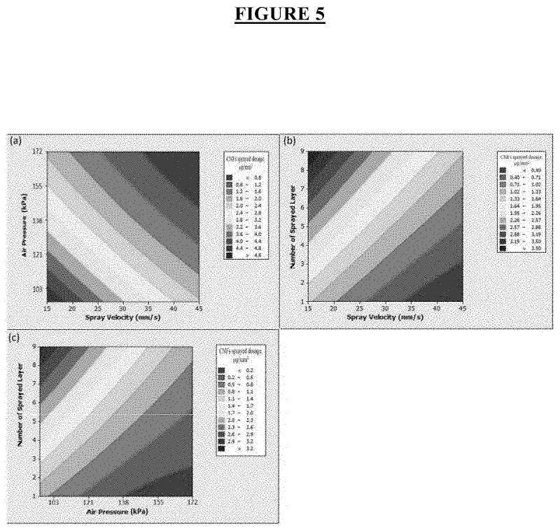

Due to the limitation of the process, a second process map is shown in in FIG. 5 by controlling spray velocity between 15 and 45 mm/s and confining air pressure between 97 to 172 kPa (14 to 25 psi). In order to keep a relatively wide adjustment of CNFs areal density, the number of sprayed layer is not confined. As shown in FIG. 5(a), setting number of sprayed layer at 5, by adjusting the spray velocity and air pressure, CNFs sprayed dosage from 0.8 to 4.8 μg/mm² can be sprayed; especially for CNFs sprayed dosage from 1.6 to 4.8 μg/mm², an accurate control can be realized. As shown in FIG. 5(b), air pressure is fixed at 152 kPa (22 psi), using different parameter combinations, CNFs sprayed dosage can range from 0.4 to 3.5 μg/mm²; within the range from 1.02 to 3.5 μg/mm², response is very sensitive to the change of variables. In FIG. 5(c), spray velocity is set at 45 mm/s, varying the combination of variables, response can be located between 0.2 and 3.2 μg/mm²; a precise density from 0.8 to 3.2 μg/mm² can be well controlled. It is observed that when two of the following three factors appear simultaneously: high spray velocity, high air pressure, or a small number of sprayed layers—there is a wide stripe where response is not sensitive to the variables. This phenomenon may ascribe to the small amount of sprayed CNFs under that combination. Thus, the inventive method uses, multilayer, medium spray velocity and medium air pressure to spray high nanoparticle sprayed dosage with accurate control. The method as shown in the process maps not only provide a fundamental understanding of the parametric influence on sprayed CNFs areal density, but one can also refer to the contour plot to choose certain variable combination for designed CNFs areal density.

### Example 1

In order to demonstrate the relationship between the spray parameters and sprayed CNF dosage, and further determine the influence of the parameters on the dispersed CNFs morphology, the sprayed fabrics were characterized using optical microscope and a field emission scanning electron microscope JEOL-6300FV.

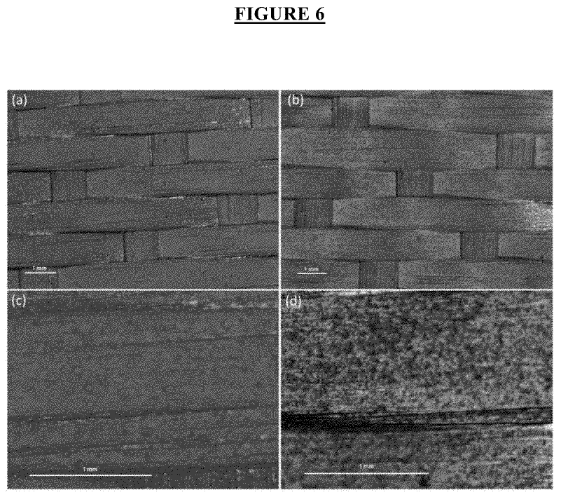

FIG. 6 shows the effect of the spray air pressure on the morphology of the sprayed fabrics: (a) and (c) are for specimen sprayed with an air pressure of 124 kPa, under low and high magnification; (b) and (d) are for specimen sprayed with an air pressure of 179 kPa, under low and high magnification. As shown in FIG. 6, (a) has a darker and thicker CNFs layer than (b), suggesting that low air pressure can help nanoparticles to deposit while high air pressure (c) decreases the coated amount of CNFs, which is in consistent with the statistical analysis. Loose CNFs bundles are observed in FIG. 6 (c) and (d), while (d) has a relative uniform distribution of these bundles, indicating the increase of air pressure favors the uniform dispersion of nanoparticles. FIG. 6 depicts that air pressure plays an important role on the dosage and morphology of sprayed CNFs.

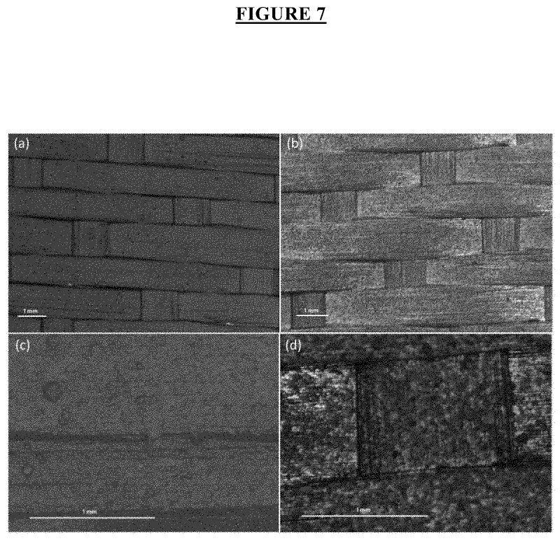

FIG. 7 shows the effect of the spray velocity on the morphology of the sprayed fabrics: (a) and (c) are for a specimen sprayed with a spray velocity of 15 mm/s, under low and high magnification; (b) and (d) are for a specimen sprayed with a spray velocity of 75 mm/s, under low and high magnification. The figure shows that both cases (with low and high velocity) have good distribution of CNFs, however, the case with lower velocity (a) and (c) seems to have denser CNFs coating than the case with higher velocity (b) and (d), showing that decreasing the velocity can increase the deposited CNFs amount. It is also noticed that relatively high velocity disperses the nanoparticles more uniformly; on the opposite, too low spray velocity may induce CNF aggregation.

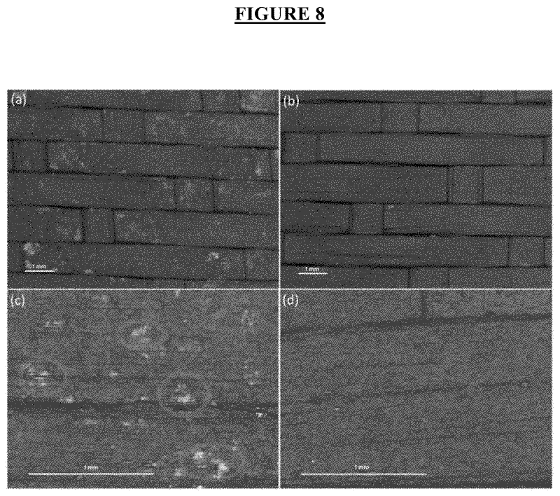

FIG. 8 shows the effect of the number of sprayed CNF layers on morphology of the sprayed fabrics; (a) and (c) are for a specimen sprayed with 3 layers, under low and high magnification; (b) and (d) are for a specimen sprayed with 7 layers, under low and high magnification As shown in the figure, (b) is darker than (a), resulted from increased layers of CNFs; it is clear that (b) has a better coating with smooth surface, indicating that multilayer spray can deposit the nanoparticles more homogeneously over the fabric. Under high magnification, it is observed that the thin CNFs film in (c), with three sprayed layers, is not as tight as in (d) with seven sprayed layers, and there are some spots not well-coated (shown in red circles). This result demonstrates that multilayer spray favors the uniform dispersion of nanoparticles.

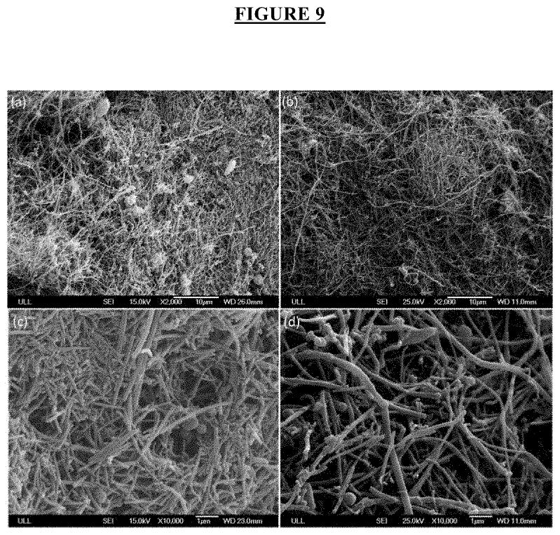

With the desire to further investigate the microstructure of the sprayed fabric, a specimen cut from case No. 2, which has the largest deposited CNFs dosage, was chosen to be observed under SEM and compared with an image sprayed by manual process. The manual spray was conducted using the same number of spray layers and same spraying air pressure as in case No. 2 using the automated spray process. As shown in FIG. 9 (a), manual spray process can generate obvious aggregation while no obvious aggregation of CNF is observed using automated atomizing spray process, shown in FIG. 9(b). Higher magnification, shown in FIGS. 9(c) and (d), further demonstrates that automated atomizing spray can realize uniform dispersion of nanoparticles, which is even better than electrophoretic deposition. Compared with CVD and electrophoretic deposition, the automated atomizing spray has a higher efficiency for hybrid nanoparticle and fabric reinforcement preparation.

The results showed that air pressure, spray velocity, and number of sprayed layer are three vital factors of the sprayed amount and morphology of CNFs: within the studied range, CNFs sprayed dosage increases with the number of spray layers, and decreases with the increase of air pressure and spray velocity. Small CNFs sprayed dosage of 0.2 μg/mm² can be easily and accurately achieved using the developed process. A regression model and process maps were developed to provide fundamental understanding of this process and recommended operation parameters for given sprayed CNFs dosage.

The characterization of the morphology of sprayed CNFs using optical microscope shows that (1) higher air pressure helps the uniform dispersion of CNFs; (2) low spray velocity increases the deposited amount of CNFs while too low velocity may induce agglomeration, but high velocity favors the uniform dispersion; (3) multilayer spray can increase the deposited amount; (4) high air pressure and high speed do not increase CNF deposited amount but they produce uniform dispersion, so multilayer spray with high pressure and high spray speed should increase the CNF deposited amount as well as form a uniform and smooth coating surface.

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

For the purpose of understanding the Method for Automated Spraying of Nanoparticles, references are made in the text to exemplary embodiments of an Method for Automated Spraying of Nanoparticles only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the Method for Automated Spraying of Nanoparticles may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

1. A method for automated spraying of nanoparticiples comprising:
a. connecting a liquid pressure supplier and an air pressure supplier to a pressure vessel wherein a solution reservoir is located and wherein said solution reservoir further comprises nanoparticles and a solvent;
b. connecting said solution reservoir to an atomizing sprayer with a tube, wherein said atomizing sprayer is fixed in a griper of a robotic arm, said robotic arm being controlled by a computer program wherein said computer program inputs comprise air pressure, velocity of said spraying, and the number of nanoparticle layers sprayed on a fixed medium; and
c. varying said air pressure, velocity of spraying, and said number of layers spread.

2. The method of claim 1 wherein said varying step further comprises varying said air pressure, velocity of spraying, and said number of layers spread independently across the surface area of said fixed medium.

3. The method of claim 1 wherein said nanoparticles comprise carbon nanofibers.

4. The method of claim 1 wherein said solvent comprises acetone.

5. The method of claim 1 wherein said solution comprises 2.5 g of CNF and 400 ml of acetone.

6. The method of claim 1 wherein said fixed medium comprises fabric sheets.

7. The method of claim 6 wherein said fabric sheets are pre-impregnated.

8. The method of claim 1 wherein said air pressure is between 120 and 180 kPa.

9. The method of claim 1 wherein said velocity of spraying is 10 millimeters per second to 80 millimeters per second.

10. The method of claim 1 wherein said number of layers sprayed is between 1 and 10.

11. An apparatus for automated spraying of nanoparticles comprising:
a. a liquid pressure supplier and an air pressure supplier connected to a pressure vessel wherein a solution reservoir is located and wherein said solution reservoir further comprises nanoparticles and a solvent; and
b. an atomizing sprayer connected to said solution reservoir with a tube, wherein said atomizing sprayer is fixed in a griper of a robotic arm, said robotic arm being controlled by a computer program wherein said computer program inputs comprise air pressure, velocity of said spraying, and the number of nanoparticle layers sprayed on a fixed medium.

12. The apparatus of claim 11 wherein said air pressure, velocity of said spraying, and said number of nanoparticle layers sprayed are varied independently across the surface of said fixed medium.

13. A method for dispersing nanoparticles in composites comprising actuating a nanoparticle sprayer wherein said nanoparticle sprayer comprises an air pressure and velocity of spray, wherein said spray comprises a plurality of nanoparticles and a solvent and wherein said actuating is performed in accordance with a process map.

14. The method of claim 13 wherein said process map comprises the response surface methodology of said composite.

15. The method of claim 13 wherein said nanoparticle spray comprises an atomizing sprayer, said atomizing sprayer being fixed in a griper of a robotic arm.
